(19) United States
(12) Patent Application Publication
(10) Pub. No.: US 2026/0067936 A1
(43) Pub. Date: Mar. 5, 2026

(54) NARROW BEAM BROADCAST FOR RANDOM ACCESS

(71) Applicant: QUALCOMM Incorporated, San Diego, CA (US)

(72) Inventors: Ran BERLINER, Kfar Aviv (IL); Konstantin KUPERSHLAK, Ramat Gan (IL); Shay LANDIS, Hod Hasharon (IL); Amit BAR-OR TILLINGER, Tel-Aviv (IL); Eitan YERUSHALMI, Tel Aviv (IL)

(21) Appl. No.: 18/824,722

(22) Filed: Sep. 4, 2024

(51) Int. Cl. H04W 74/0833; H04W 72/0453

(52) U.S. Cl. CPC H04W 74/0833; H04W 72/0453

(57) ABSTRACT

Methods, systems, and devices for wireless communications at a user equipment (UE) are described. The UE may receive control signaling indicating a plurality of synchronization signal block (SSB) occasions for a plurality of SSB beams and indicating a plurality of random access occasions. The UE may monitor a first SSB beam of the plurality of SSB beams may monitor a plurality of reference signal beams associated with the first SSB beam, where each beam of the plurality of reference signal beams has a narrower beamwidth than the first SSB beam, and where each beam of the plurality of reference signal beams is quasi co-located and frequency domain multiplexed with the first SSB beam. The UE may transmit a random access message during a first random access occasion, the first random access occasion indicating a first reference signal beam selected from the plurality of reference signal beams.

### FIELD OF TECHNOLOGY

The following relates to wireless communications, including narrow beam broadcast for random access.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a wireless device may perform a random access procedure. However, such approaches may be improved.

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving control signaling indicating a set of multiple synchronization signal block (SSB) occasions for a set of multiple SSB beams and indicating a set of multiple random access occasions, monitoring, in accordance with the control signaling, a first SSB beam of the set of multiple SSB beams during a first SSB occasion of the set of multiple SSB occasions, monitoring, during the first SSB occasion, a set of multiple reference signal beams associated with the first SSB beam, where each beam of the set of multiple reference signal beams has a narrower beamwidth than the first SSB beam, and where each beam of the set of multiple reference signal beams is quasi co-located and frequency domain multiplexed with the first SSB beam, and transmitting a random access message during a first random access occasion of the set of multiple random access occasions, the first random access occasion indicating a first reference signal beam selected from the set of multiple reference signal beams.

A UE for wireless communications is described. The UE may include one or more memories storing processor executable code, and one or more processors coupled with the one or more memories. The one or more processors may individually or collectively be operable to execute the code to cause the UE to receive control signaling indicating a set of multiple synchronization signal block (SSB) occasions for a set of multiple SSB beams and indicating a set of multiple random access occasions, monitor, in accordance with the control signaling, a first SSB beam of the set of multiple SSB beams during a first SSB occasion of the set of multiple SSB occasions, monitor, during the first SSB occasion, a set of multiple reference signal beams associated with the first SSB beam, where each beam of the set of multiple reference signal beams has a narrower beamwidth than the first SSB beam, and where each beam of the set of multiple reference signal beams is quasi co-located and frequency domain multiplexed with the first SSB beam, and transmit a random access message during a first random access occasion of the set of multiple random access occasions, the first random access occasion indicating a first reference signal beam selected from the set of multiple reference signal beams.

Another UE for wireless communications is described. The UE may include means for receiving control signaling indicating a set of multiple synchronization signal block (SSB) occasions for a set of multiple SSB beams and indicating a set of multiple random access occasions, means for monitoring, in accordance with the control signaling, a first SSB beam of the set of multiple SSB beams during a first SSB occasion of the set of multiple SSB occasions, means for monitoring, during the first SSB occasion, a set of multiple reference signal beams associated with the first SSB beam, where each beam of the set of multiple reference signal beams has a narrower beamwidth than the first SSB beam, and where each beam of the set of multiple reference signal beams is quasi co-located and frequency domain multiplexed with the first SSB beam, and means for transmitting a random access message during a first random access occasion of the set of multiple random access occasions, the first random access occasion indicating a first reference signal beam selected from the set of multiple reference signal beams.

A non-transitory computer-readable medium storing code for wireless communications is described. The code may include instructions executable by one or more processors to receive control signaling indicating a set of multiple synchronization signal block (SSB) occasions for a set of multiple SSB beams and indicating a set of multiple random access occasions, monitor, in accordance with the control signaling, a first SSB beam of the set of multiple SSB beams during a first SSB occasion of the set of multiple SSB occasions, monitor, during the first SSB occasion, a set of multiple reference signal beams associated with the first SSB beam, where each beam of the set of multiple reference signal beams has a narrower beamwidth than the first SSB beam, and where each beam of the set of multiple reference signal beams is quasi co-located and frequency domain multiplexed with the first SSB beam, and transmit a random access message during a first random access occasion of the set of multiple random access occasions, the first random access occasion indicating a first reference signal beam selected from the set of multiple reference signal beams.

In some examples of the method, user equipment (UEs), and non-transitory computer-readable medium described herein, monitoring the set of multiple reference signal beams may include operations, features, means, or instructions for monitoring for a respective reference signal beam of the set of multiple reference signal beams in a respective symbol period of a set of multiple symbol periods of the first SSB occasion.

In some examples of the method, user equipment (UEs), and non-transitory computer-readable medium described herein, monitoring the set of multiple reference signal beams may include operations, features, means, or instructions for monitoring for the set of multiple reference signal beams in a first frequency resource that may be frequency domain multiplexed with a second frequency resource of the first SSB beam.

In some examples of the method, user equipment (UEs), and non-transitory computer-readable medium described herein, monitoring the set of multiple reference signal beams may include operations, features, means, or instructions for monitoring for the set of multiple reference signal beams in a first set of multiple frequency resources, where each frequency resource of the first set of multiple frequency resources may be frequency domain multiplexed with a second frequency resource of the first SSB beam.

In some examples of the method, user equipment (UEs), and non-transitory computer-readable medium described herein, each reference signal beam of the set of multiple reference signal beams may be associated with a different random access occasion of the set of multiple random access occasions.

In some examples of the method, user equipment (UEs), and non-transitory computer-readable medium described herein, each reference signal beam of the set of multiple reference signal beams may be associated with a different random access preamble of a set of multiple random access preambles and the random access message includes a first random access preamble of the set of multiple random access preambles, the first random access preamble corresponding to the first reference signal beam and the first random access occasion.

In some examples of the method, user equipment (UEs), and non-transitory computer-readable medium described herein, one or more resources associated with one or more of the set of multiple reference signal beams may be misaligned with a global synchronization channel number grid.

In some examples of the method, user equipment (UEs), and non-transitory computer-readable medium described herein, the set of multiple reference signal beams includes a set of multiple channel state information reference signal (CSI-RS) beams, a set of multiple primary synchronization signal (PSS) beams, a set of multiple secondary synchronization signal (SSS) beams, or any combination thereof.

In some examples of the method, user equipment (UEs), and non-transitory computer-readable medium described herein, receiving the control signaling may include operations, features, means, or instructions for receiving the control signaling that indicates a quantity of reference signal beams per SSB occasion.

In some examples of the method, user equipment (UEs), and non-transitory computer-readable medium described herein, receiving the control signaling may include operations, features, means, or instructions for receiving the control signaling that indicates a quantity of random access preambles per reference signal beam.

A method for wireless communications by a network entity is described. The method may include transmitting control signaling indicating a set of multiple synchronization signal block (SSB) occasions for a set of multiple SSB beams and indicating a set of multiple random access occasions, transmitting, in accordance with the control signaling, a first SSB beam of the set of multiple SSB beams during a first SSB occasion of the set of multiple SSB occasions, transmitting, during the first SSB occasion, a set of multiple reference signal beams associated with the first SSB beam, where each beam of the set of multiple reference signal beams has a narrower beamwidth than the first SSB beam, and where each beam of the set of multiple reference signal beams is quasi co-located and frequency domain multiplexed with the first SSB beam, and receiving a random access message during a first random access occasion of the set of multiple random access occasions, the first random access occasion indicating a first reference signal beam selected from the set of multiple reference signal beams.

A network entity for wireless communications is described. The network entity may include one or more memories storing processor executable code, and one or more processors coupled with the one or more memories. The one or more processors may individually or collectively be operable to execute the code to cause the network entity to transmit control signaling indicating a set of multiple synchronization signal block (SSB) occasions for a set of multiple SSB beams and indicating a set of multiple random access occasions, transmit, in accordance with the control signaling, a first SSB beam of the set of multiple SSB beams during a first SSB occasion of the set of multiple SSB occasions, transmit, during the first SSB occasion, a set of multiple reference signal beams associated with the first SSB beam, where each beam of the set of multiple reference signal beams has a narrower beamwidth than the first SSB beam, and where each beam of the set of multiple reference signal beams is quasi co-located and frequency domain multiplexed with the first SSB beam, and receive a random access message during a first random access occasion of the set of multiple random access occasions, the first random access occasion indicating a first reference signal beam selected from the set of multiple reference signal beams.

Another network entity for wireless communications is described. The network entity may include means for transmitting control signaling indicating a set of multiple synchronization signal block (SSB) occasions for a set of multiple SSB beams and indicating a set of multiple random access occasions, means for transmitting, in accordance with the control signaling, a first SSB beam of the set of multiple SSB beams during a first SSB occasion of the set of multiple SSB occasions, means for transmitting, during the first SSB occasion, a set of multiple reference signal beams associated with the first SSB beam, where each beam of the set of multiple reference signal beams has a narrower beamwidth than the first SSB beam, and where each beam of the set of multiple reference signal beams is quasi co-located and frequency domain multiplexed with the first SSB beam, and means for receiving a random access message during a first random access occasion of the set of multiple random access occasions, the first random access occasion indicating a first reference signal beam selected from the set of multiple reference signal beams.

A non-transitory computer-readable medium storing code for wireless communications is described. The code may include instructions executable by one or more processors to transmit control signaling indicating a set of multiple synchronization signal block (SSB) occasions for a set of multiple SSB beams and indicating a set of multiple random access occasions, transmit, in accordance with the control signaling, a first SSB beam of the set of multiple SSB beams during a first SSB occasion of the set of multiple SSB occasions, transmit, during the first SSB occasion, a set of multiple reference signal beams associated with the first SSB beam, where each beam of the set of multiple reference signal beams has a narrower beamwidth than the first SSB beam, and where each beam of the set of multiple reference signal beams is quasi co-located and frequency domain multiplexed with the first SSB beam, and receive a random access message during a first random access occasion of the set of multiple random access occasions, the first random access occasion indicating a first reference signal beam selected from the set of multiple reference signal beams.

In some examples of the method, network entities, and non-transitory computer-readable medium described herein, transmitting the set of multiple reference signal beams may include operations, features, means, or instructions for transmitting a respective reference signal beam of the set of multiple reference signal beams in a respective symbol period of a set of multiple symbol periods of the first SSB occasion.

In some examples of the method, network entities, and non-transitory computer-readable medium described herein, transmitting the set of multiple reference signal beams may include operations, features, means, or instructions for transmitting the set of multiple reference signal beams in a first frequency resource that may be frequency domain multiplexed with a second frequency resource of the first SSB beam.

In some examples of the method, network entities, and non-transitory computer-readable medium described herein, transmitting the set of multiple reference signal beams may include operations, features, means, or instructions for transmitting the set of multiple reference signal beams in a first set of multiple frequency resources, where each frequency resource of the first set of multiple frequency resources may be frequency domain multiplexed with a second frequency resource of the first SSB beam.

In some examples of the method, network entities, and non-transitory computer-readable medium described herein, each reference signal beam of the set of multiple reference signal beams may be associated with a different random access occasion of the set of multiple random access occasions.

In some examples of the method, network entities, and non-transitory computer-readable medium described herein, each reference signal beam of the set of multiple reference signal beams may be associated with a different random access preamble of a set of multiple random access preambles and the random access message includes a first random access preamble of the set of multiple random access preambles, the first random access preamble corresponding to the first reference signal beam and the first random access occasion.

In some examples of the method, network entities, and non-transitory computer-readable medium described herein, one or more resources associated with one or more of the set of multiple reference signal beams may be misaligned with a global synchronization channel number grid.

In some examples of the method, network entities, and non-transitory computer-readable medium described herein, the set of multiple reference signal beams includes a set of multiple channel state information reference signal (CSI-RS) beams, a set of multiple PSS beams, a set of multiple SSS beams, or any combination thereof.

In some examples of the method, network entities, and non-transitory computer-readable medium described herein, transmitting the control signaling may include operations, features, means, or instructions for transmitting the control signaling that indicates a quantity of reference signal beams per SSB occasion.

In some examples of the method, network entities, and non-transitory computer-readable medium described herein, transmitting the control signaling may include operations, features, means, or instructions for transmitting the control signaling that indicates a quantity of random access preambles per reference signal beam.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports narrow beam broadcast for random access in accordance with one or more examples as disclosed herein.

FIG. 2 shows an example of a wireless communications system that supports narrow beam broadcast for random access in accordance with one or more examples as disclosed herein.

FIG. 3 shows an example of a random access schemes that supports narrow beam broadcast for random access in accordance with one or more examples as disclosed herein.

FIG. 4 shows an example of a random access scheme that supports narrow beam broadcast for random access in accordance with one or more examples as disclosed herein.

FIG. 5 shows an example of a process flow that supports narrow beam broadcast for random access in accordance with one or more examples as disclosed herein.

FIGS. 6 and 7 show block diagrams of devices that support narrow beam broadcast for random access in accordance with one or more examples as disclosed herein.

FIG. 8 shows a block diagram of a communications manager that supports narrow beam broadcast for random access in accordance with one or more examples as disclosed herein.

FIG. 9 shows a diagram of a system including a device that supports narrow beam broadcast for random access in accordance with one or more examples as disclosed herein.

FIGS. 10 and 11 show block diagrams of devices that support narrow beam broadcast for random access in accordance with one or more examples as disclosed herein.

FIG. 12 shows a block diagram of a communications manager that supports narrow beam broadcast for random access in accordance with one or more examples as disclosed herein.

FIG. 13 shows a diagram of a system including a device that supports narrow beam broadcast for random access in accordance with one or more examples as disclosed herein.

FIGS. 14 and 15 show flowcharts illustrating methods that support narrow beam broadcast for random access in accordance with one or more examples as disclosed herein.

### DETAILED DESCRIPTION

In wireless communications, a user equipment (UE) may perform a random access (RA) procedure (e.g., such as an RA channel (RACH) procedure, or an initial access (IA) procedure). However, in such procedures, the UE may perform the RA procedure using wide beams, which may result in engaging in a beam refinement procedure using narrow beams after performing the RA procedure. Such a scenario involves additional overhead and latency to perform the beam refinement procedure after the RA procedure.

A network entity may transmit both wide and narrow beams during SSB symbols for cell searching. The wide and narrow beams may be quasi co-located (QCL-ed), frequency domain multiplexed (FDM-ed) or both. Further, the network entity may transmit a configuration (e.g., in the SSB) that indicates the wide beams and narrow beams so that the UE may identify a narrow beam to use for the RA procedure. The UE may monitor for reference signals to ascertain and measure the wide beams, the narrow beams, or both, and may select a beam (e.g., based on one or more measurements, metrics, or characteristics associated with the reference signals). The UE may transmit a report indicating one or more selected narrow beams and may perform the RA procedure using the narrow beams. In at least these ways, RA coverage may be enhanced due to the use of the narrow beams during the RA procedure. Additionally, or alternatively, communications overhead and latency may be reduced, as no further beam refinement procedure may be performed and the RA procedure itself already utilizes narrow beams.

Aspects of the disclosure are initially described in the context of wireless communications systems. Aspects of the disclosure are then described with reference to a wireless communications system, random access schemes, and a process flow. Aspects of the disclosure are further illustrated by and described with reference to apparatus diagrams, system diagrams, and flowcharts that relate to narrow beam broadcast for random access.

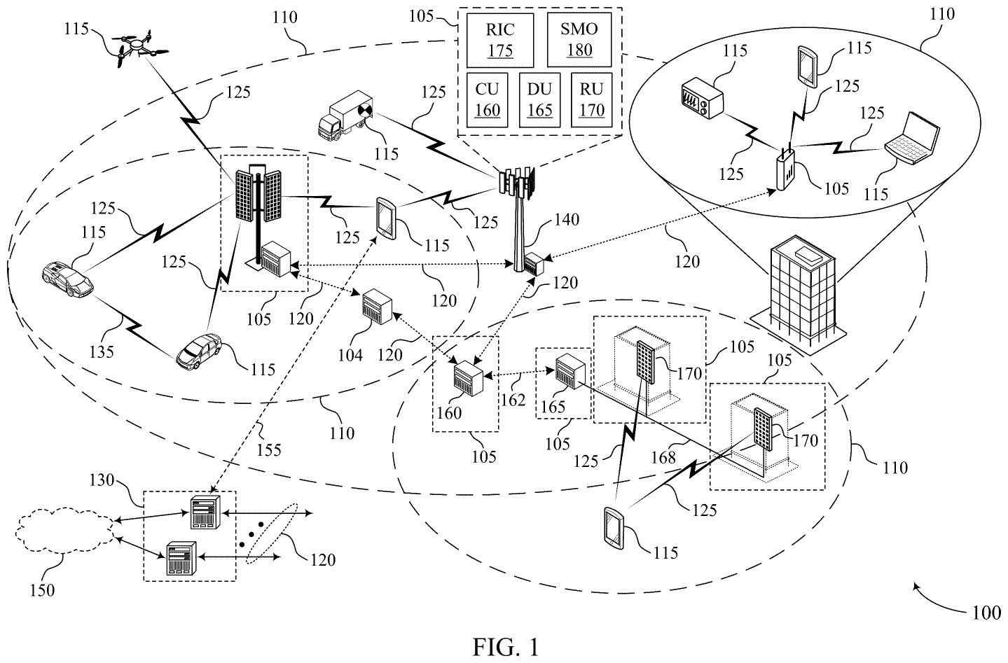

FIG. 1 shows an example of a wireless communications system 100 that supports narrow beam broadcast for random access in accordance with one or more examples as disclosed herein. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some implementations, a UE 115 may monitor for both wide and narrow beams transmitted from a network entity during a RA procedure. For example, the UE 115 may monitor for an SSB to be received via a wide beam and may further monitor for a reference signal to be received via a narrow beam. In some examples, multiple reference signals may be transmitted via multiple narrow beams to allow the UE 115 to select one or more beams to be used for performing the RA procedure or for subsequent communications. In some examples, the UE 115 may receive information about the wide beams and the narrow beams (e.g., regarding one or more occasions in which the UE 115 is to monitor for the wide beams and the narrow beams) to aid the UE in selecting the narrow beam to use for the RA procedure.

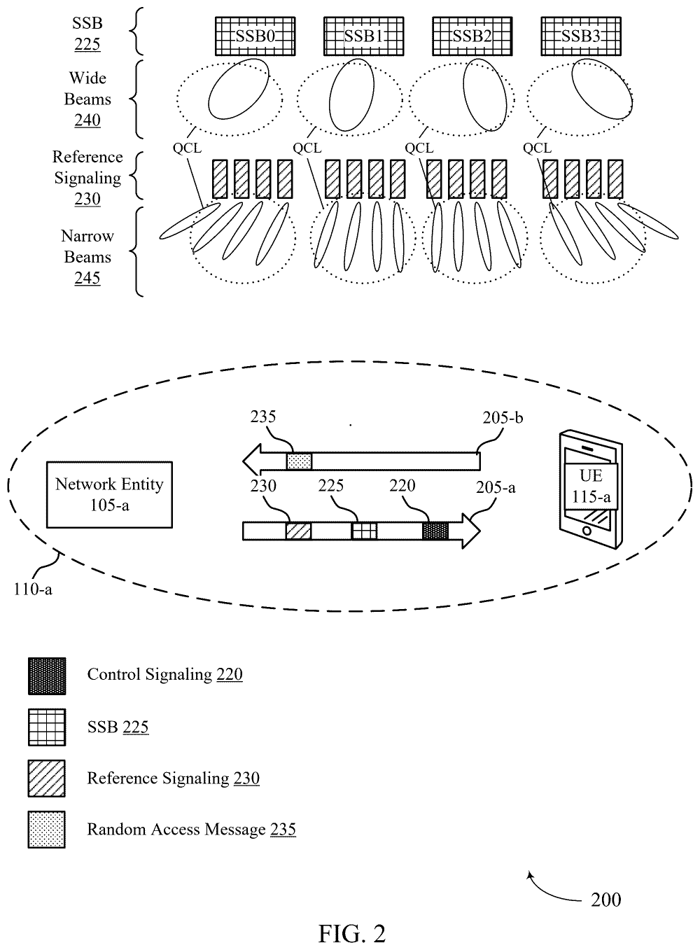

FIG. 2 shows an example of a wireless communications system 200 that supports narrow beam broadcast for random access in accordance with one or more examples as disclosed herein.

The wireless communications system 200 may include the network entity 105-a, which may be an example of one or more network entities discussed in relation to other figures. The wireless communications system 200 may include the UE 115-a, which may be an example of UEs discussed in relation to other figures. In some examples, the UE 115-a may be located in a geographic coverage area 110-a that may be associated with the network entity 105-a. The network entity 105-a and UE 115-a may communicate via one or more downlink communication links 205-a and one or more uplink communication links 205-b.

In some wireless communications environments (e.g., involving high frequency bands and beamformed communications), a UE 115-a may perform an IA, which may involve one or more operations, including performing an RA procedure (e.g., a RACH procedure) on an observed (e.g., wide) SSB beam, which may include communication of RA messages 1-4. Following a successful dedicated RRC setup completion, the network entity may trigger a network entity-side beam refinement procedure (a.k.a. a P2 procedure). In some examples, the transition to a narrow network entity beam may be either transparent (e.g., if there is no transmission configuration indicator (TCI) state change) or may be explicitly triggered by a beam switch procedure. In some examples, for improved beam pairing, the network entity may optionally trigger a UE beam refinement procedure (e.g., a P3 procedure). Additionally, or alternatively, a UE may autonomously refine one or more beams by using the spatially associated SSB occasions for UE beam refinement (e.g., when not used for radio resource management (RRM) measurements or control loops tracking).

However, in some examples, beam management operations may be supported during or in association with an RRC connection, rather than during or associated with initial access procedures. For example, an RA procedure may be performed using wide beams. In some examples, UEs located near a cell edge may use a repetition-based RA procedure, such as a repetition-based RACH procedure. In some examples, the P2 and P3 procedures may involve an RRC connection and may introduce resource overhead.

The techniques described herein may include the network entity broadcasting narrow beams with efficient resource overhead, which may enable early beam management during initial access procedures, performance of an RA procedure over narrow beams, and periodic beam refinement procedures (e.g., P2 and possibly P3 procedures) with efficient resource overhead for high band communications operations.

In some techniques, a UE may not be expected to transmit or output uplink signaling (e.g., physical uplink control channel (PUCCH) signaling, physical uplink shared channel (PUSCH) signaling, or sounding reference signal (SRS) signaling) or receive or obtain downlink signaling (e.g., physical downlink control channel (PDCCH) signaling, physical downlink shared channel (PDSCH) signaling, tracking reference signal (TRS) signaling, or channel state information reference signal (CSI-RS) signaling) on SSB symbols to be measured. For example, UEs operating in high bands may not be expected to be scheduled with dedicated resources during SSB symbols to be measured within an SSB based measurement timing configuration (SMTC) window.

Further, in some techniques, (e.g., for the synchronization signal/physical broadcast channel (SS/PBCH) block and control resource set (CORESET) multiplexing patterns, such as multiplexing patterns 2 and 3), a UE may monitor a PDCCH in a PDCCH common search space (CSS) set over a slot with a periodicity (e.g., a Type0-PDCCH CSS set periodicity) equal to the periodicity of the SS/PBCH block. For example, in some patterns involving SS/PBCH block and CORESET multiplexing patterns (e.g., pattern 2, in which a CORESET transmission is made in a first time resource and a PDSCH transmission and the SS/PBCH block transmission are frequency division multiplexed in a same time resource, or pattern 3, in which a first portion of an SS/PBCH block transmission is frequency division multiplexed with a CORESET transmission and a second portion of the SS/PBCH block is frequency division multiplexed with a PDSCH transmission), a system information block (SIB) transmission, such as SIB1, is scheduled during spatially associated SSB symbols. This may differ from other scenarios (e.g., pattern 1, in which an SS/PBCH block transmission, a CORESET transmission, and a PDSCH transmission are time division multiplexed) in which a SIB, such as SIB1, may be transmitted or output in other symbols.

In some examples, the network entity 105-a may transmit or output the reference signaling 230 over the narrow beams 240 during symbols in which the SSBs 225 are also transmitted or output via the wide beams 240, where the narrow beams 245 are QCL-ed and FDM-ed with the wide beams 240. For example, the network entity 105-a may transmit or output the SSBs 225 via the wide beams 240 in same time resources within which the network entity 105-a may also transmit or output the reference signaling 230 over the narrow beams, but the reference signaling 230 and the SSBs 225 may be transmitted or output in different frequency resources (e.g., in an FDM manner). Further, in some examples, the wide beams 240 may occupy or be associated with spatial resources in which the narrow beams 245 are located (e.g., each narrow beam 245 that is QCL'd with a wide beam 240 may occupy a portion of the spatial resources occupied by the QCL'd wide beam 240). Further, in some examples, an SSB, such as SSB0, may be transmitted or output or output over multiple symbol periods, such as four symbol periods. In each of the multiple symbol periods associated with the SSB0, corresponding reference signaling 230 may be transmitted or output or output over a narrow beam 245, such that each symbol period associated with the SSB0 may be associated with a different narrow beam 245 that is QCL'd with the wide beam 240 of SSB0. Further, in some examples, each of the narrow beams 245 QCL'd with a wide beam 240 may be oriented in respective directions towards a direction of the associated wide beam 240. In some examples, each of the narrow beams 245 may be oriented in directions that are different than other directions of other narrow beams 245 associated with the wide beam 240 but are still towards or near (e.g., within a threshold angle) a direction of the wide beam 240.

In some examples, the reference signaling 230 transmitted or output via the narrow beams 245 may include one or more types of reference signaling, including CSI-RS signaling (e.g., non-zero power CSI-RS (NZP-CSI-RS), one or more repeated sync signals (e.g., a primary synchronization symbol (PSS) or secondary synchronization signal (SSS)), an SSB transmission (e.g., a 4 symbols SSB or other SSB), or any combination thereof. In some examples, the signaling 230 associated with the narrow beams 245 may be on or off of a global synchronization channel number (GSCN) grid, based or (off GSCN grid). In some examples, the pattern or configuration of the narrow beams 245 may be published by the network entity 105-a, such as through a master information block (MIB) transmission, a SIB transmission (e.g., via SIB1) or other communications associated with the network entity 105-a.

Such techniques may differ from other approaches, at least because other approaches do not include concurrent transmission of other transmissions with SSB 225 transmissions (e.g., other than SIB1 multiplexing patterns 2 and 3, as described herein). By employing such techniques, the narrow beams 245 may be periodically broadcasted overlapping in time with the SSBs 225, enabling early beam management. Further, initial access procedures (e.g., a RA procedure, such as a RACH procedure) may be performed over narrow beams earlier than in other approaches (e.g., from the first message of the RA procedure).

In some examples, the network entity 105-a may transmit or output the control signaling 220 that may indicate the arrangement, configuration, or other information about the SSBs 225, the wide beams 240, the reference signaling 230, the narrow beams 245, or any combination thereof to allow the UE 115-a to monitor for the wide beams 240 and the narrow beams 245. For example, the control signaling may indicate a plurality of SSB occasions in which the SSBs 225 are to be transmitted or output or output over the wide beams 240 and during which the reference signaling 230 is to be transmitted or output or output over the narrow beams 245. In some examples, the UE 115-a may monitor (e.g., in one or more SSB occasions of the plurality of SSB occasions) a first wide beam 240 and may further monitor one or more narrow beams 245 that are associated with a wide beam 240. For example, the UE 115-a may monitor during or in association with a TTI, such as one or more symbol periods or a set of symbol periods. During such a TTI, symbol period, or set of symbol periods, both the SSBs 225 and the reference signaling 230 may be transmitted or output or output using the wide beams 240 and the narrow beams 245, respectively. In some examples, the wide beams 240 and the narrow beams 245 may be utilized in the same or overlapping time resources (e.g., the TTI, symbol periods, or set of symbol periods). In some examples, the wide beams 240 and the narrow beams 245 may be utilized in different frequency resources (e.g., in an FDM manner). In some examples, the wide beams 240 and the narrow beams 245 may be QCL'd and sources, directions, orientations, or any combination thereof, of narrow beams 245 may be associated with or related to those of the corresponding wide beam 240.

In some examples, the UE 115-a may monitor narrow beams 245 that are QCL-ed and FDM-ed with one of the SSBs 22 (e.g., SSB1). In some examples, the UE 115-a may transmit or output a random access message 235 using a narrow beam that corresponds with a narrow beam 245 employed by the network entity 105-a and the UE 115-a may further indicate that narrow beam 245 selected by the UE 115-a for further communications.

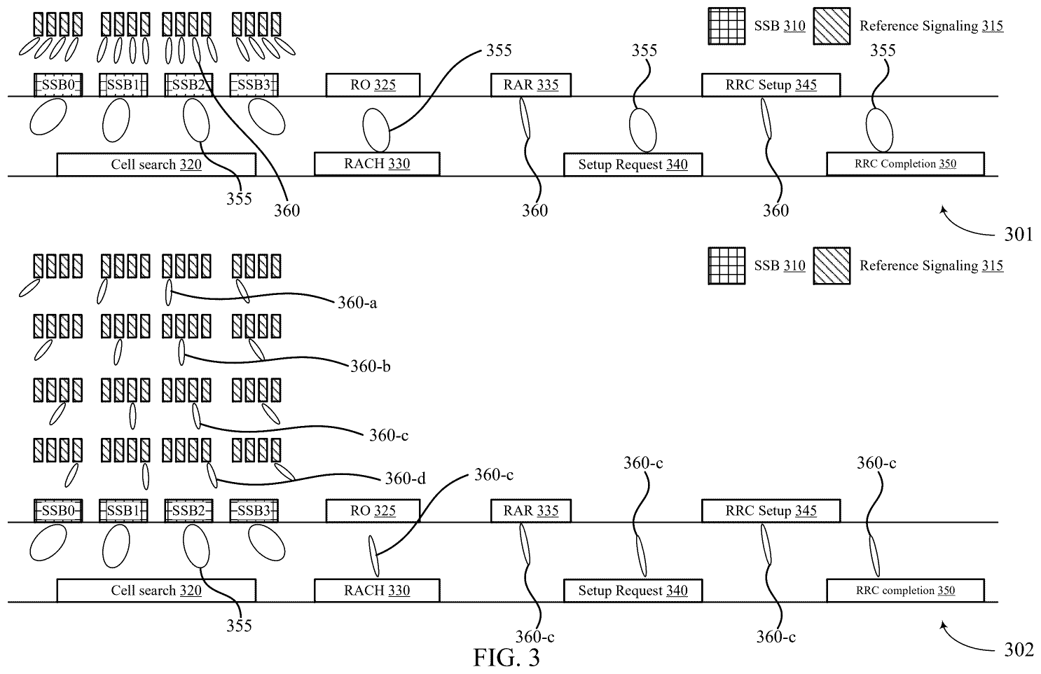

FIG. 3 shows an example of a random access schemes, including random access scheme 301 and random access scheme 302, that support narrow beam broadcast for random access in accordance with one or more examples as disclosed herein.

In some examples, in the presence of broadcasted narrow beams, a RA procedure may be performed. Though a RACH procedure is described here as an example, other RA procedures and modified RACH procedures may also be performed using these techniques. For example, a RACH procedure may be performed partially or entirely over narrow beams during initial access. Random access scheme 301 provides an example in which the UE may employ wide beams for transmissions (e.g., at the RACH 330, the setup request 340, and the RRC completion 350) and the network entity may employ narrow beams for a random access response (RAR), such as the RAR 335 and the RRC setup 345 (e.g., after the network entity transmit or outputs the SSBs 310 and the reference signaling 315 over the wide beams and the narrow beams, respectively, during the cell search 320 phase for the UE to establish communications using the narrow beams). Additionally, or alternatively, the random access scheme 302 provides an example in which transmissions of the network entity and the UE (e.g., the RO 325, the RACH 330, the RAR 335, the setup request 340, the RRC setup 345, and the RRC completion 350) may be performed using narrow beams (e.g., after the network entity transmit or outputs the SSBs 310 and the reference signaling 315 over the wide beams and the narrow beams, respectively, during the cell search 320 phase for the UE to establish communications using the narrow beams).

As described herein, a network entity may transmit or output the SSBs 310 over wide beams and reference signaling 315 over narrow beams. For example, a network entity may transmit or output the SSBs 310 via wide beams (e.g., in one or more SSB occasions) in same or at least partially overlapping time resources within which the network entity may also transmit or output the reference signaling 315 over the narrow beams, but the reference signaling 315 and the SSBs 310 may be transmit or outputted or output in different frequency resources (e.g., in an FDM manner). For example, the SSBs 310 may be transmitted or output over the wide beams and in first frequency resources that do not overlap with (e.g., are frequency domain multiplexed with) second frequency resources in which the reference signaling 315 is transmit or outputted or output over the narrow beams. Further, in some examples, the wide beams may occupy or be associated with spatial resources in which the narrow beams are located (e.g., each narrow beam that is QCL'd with a wide beam may occupy a portion of the spatial resources occupied by the QCL'd wide beam). Further, in some examples, an SSB, such as SSB0, may be transmit or output over multiple symbol periods, such as four symbol periods. In each of the multiple symbol periods associated with the SSB0, corresponding reference signaling 315 may be transmit or outputted or output over a narrow beam, such that each symbol period associated with the SSB0 may be associated with a different narrow beam that is QCL'd with the wide beam of SSB0. Further, in some examples, each of the narrow beams QCL'd with a wide beam may be oriented in respective directions towards a direction of the associated wide beam. In some examples, each of the narrow beams may be oriented in directions that are different than other directions of other narrow beams associated with the wide beam but are still towards or near (e.g., within a threshold angle) a direction of the wide beam.

In some examples (e.g., to facilitate RACH procedures using narrow beams), one or more narrow beams may be associated with a RACH occasion (RO), such as the RO 325, a preamble group, or both. For example, for the RACH 330, which may be an example of a Msg1 of a RACH procedure, the UE may select a network entity narrow beam (e.g., based on one or more signal or communication characteristics, such as those that satisfy one or more thresholds) and may employ the associated RO 325 and preamble that are associated with the selected narrow beam.

By broadcasting the narrow beams, the network entity enables or allows the UE to refine beams for communication of a first RACH message (e.g., the RACH 330, which may be an example of a Msg1), which may be helpful, but not limited to, SSB-based narrow beams. Such techniques allow the UE and the network entity to communicate using improved quality link pairs from the beginning of the process. Further, in some examples, the network entity may use the transmission of Msg1 or RACH 330 to derive or determine which narrow beam was selected by the UE, which is to be used for the subsequent communications (be they part of the RACH procedure, for other subsequent communications, or any combination thereof).

For example, the network entity may transmit or output, among other wide beams, the wide beam 355 associated with SSB2 (e.g., in one or more SSB occasions). Further, the network entity may transmit or output, among other narrow beams QCL'd and FDM'd with the wide beam 355, the narrow beam 360. As part of the cell search 320, the UE may identify a wide beam (e.g., based on one or more characteristics or measurements) for use and may further identify a narrow beam (e.g., based on one or more characteristics or measurements) for use. For example, the UE may identify the wide beam 355 and the narrow beam 360 to be used for communications during a RACH process. The narrow beam 360 may be associated with (e.g., may be QCL'd and FDM'd with) the wide beam 355. For example, the network entity may transmit or output the SSBs 310 over the wide beams, such as the wide beam 355, in first frequency resources that do not overlap (e.g., are frequency domain multiplexed) with second frequency resources in which the network entity transmit or outputs the reference signaling 315 over the narrow beams, such as the narrow beam 360. In some examples, the network entity and the UE may communicate using only wide beams, only narrow beams, or a combination of wide beams and narrow beams.

For example, the network entity and the UE may communicate using the wide beam 355 and the narrow beam 360. For example, at the RACH 330, the UE may transmit or output a RACH message using the wide beam 355 during or in association with the RO 325. At the RAR 335 the network entity may transmit or output a RAR message using the narrow beam 360. At the setup request 340, the UE may transmit or output a setup request message using the wide beam 355. At the RRC setup 345, the network entity may transmit or output an RRC setup message using the narrow beam 360. At the RRC completion 350, the UE may transmit or output an RRC completion message using the wide beam 355.

In some other approaches, beam refinement may not be performed during or in association with random access and may instead be available in association with connected mode operations. In contrast, early beam management during initial access (e.g., during states such as RRC_IDLE or RRC_INACTIVE) allows for improved coverage, communications quality, latency, and reliability, without affecting overhead for communications.

In some examples, such as in the random access scheme 301, the narrow beams may be transmit or output in an at least partially simultaneously or overlapping fashion, whereas in the random access scheme 302, the network entity may sweep through different narrow beams over a period of time. In either case, as well as in other cases, the narrow beams are made available to the UE for selection and subsequent communication during the RACH procedure. For example, during a time period (e.g., in one or more SSB occasions), the network entity may transmit or output the SSB2 over the wide beam 355. Further, during respective portions of the time period, the network entity may transmit or output the narrow beam 360-a, the narrow beam 360-b, the narrow beam 360-c, and the narrow beam 360-d. In at least this way, the network entity may “sweep” through multiple narrow beams 360 that are associated with the wide beam 355, allowing a UE to identify the wide beam 355 and the associated narrow beams 360.

For example, similar to the random access scheme 301, in the random access scheme 302, a network entity may transmit or output the SSBs 310 via wide beams in same time resources (e.g., in one or more SSB occasions) within which the network entity may also transmit or output the reference signaling 315 over the narrow beams, but the reference signaling 315 and the SSBs 310 may be transmit or output in different frequency resources (e.g., in an FDM manner). Further, in some examples, the wide beams may occupy or be associated with spatial resources in which the narrow beams are located (e.g., each narrow beam that is QCL'd with a wide beam may occupy a portion of the spatial resources occupied by the QCL'd wide beam). Further, in some examples, an SSB, such as SSB0, may be transmit or outputted or output over multiple symbol periods, such as four symbol periods. In each of the multiple symbol periods associated with the SSB0, corresponding reference signaling 315 may be transmit or outputted or output over a narrow beam, such that each symbol period associated with the SSB0 may be associated with a different narrow beam that is QCL'd with the wide beam of SSB0. Further, in some examples, each of the narrow beams QCL'd with a wide beam may be oriented in respective directions towards a direction of the associated wide beam. In some examples, each of the narrow beams may be oriented in directions that are different than other directions of other narrow beams associated with the wide beam but are still towards or near (e.g., within a threshold angle) a direction of the wide beam.

In some examples, in the random access scheme 302, the network entity may transmit or output, among other wide beams, the wide beam 355 associated with SSB2. Further, the network entity may transmit or output, among other narrow beams QCL'd and FDM'd with the wide beam 355, the narrow beam 360-c. As part of the cell search 320, the UE may identify a wide beam (e.g., based on one or more characteristics or measurements) for use and may further identify a narrow beam (e.g., based on one or more characteristics or measurements) for use. For example, the UE may identify the wide beam 355 and the narrow beam 360-c to be used for communications during a RACH process. The narrow beam 360-c may be associated with (e.g., may be QCL'd and FDM'd with) the wide beam 355. However, in the random access scheme 302, the network entity and the UE may communicate using the narrow beam 360-c (e.g., without using any wide beams beyond the use of the wide beam 355 during the cell search 320, where, by identifying the wide beam 355, the UE may be aided in identifying the narrow beam 360 or other narrow beam associated with the wide beam 355).

For example, during the cell search 320, the UE may identify the wide beam 355 and may further identify (e.g., based on identifying the wide beam 355), the narrow beam 360-c. The network entity, the UE, or both, may then employ the narrow beam 360 for communications at multiple portions of the RACH procedure, including the RACH 330 (e.g., during or in association with the RO 325), the RAR 335, the setup request 340, the RRC setup 345, the RRC completion 350, or any combination thereof.

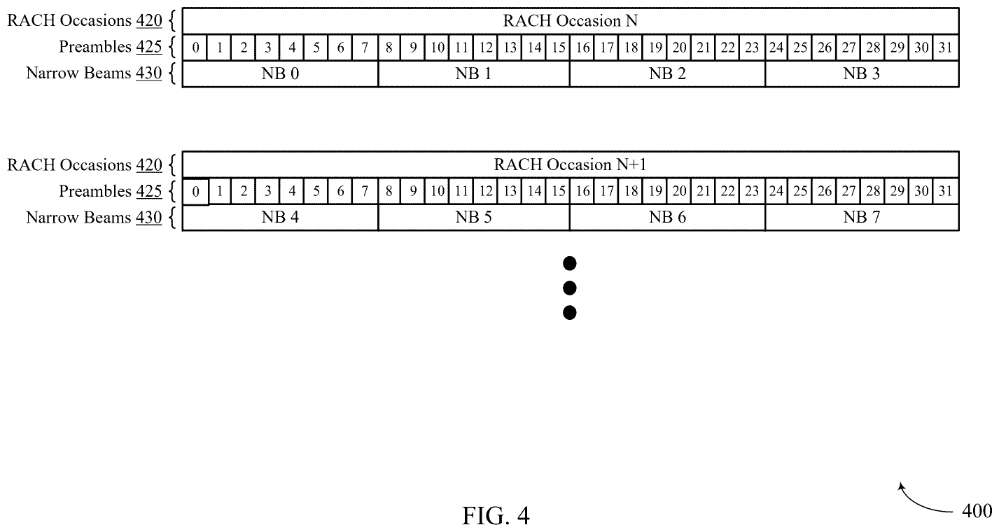

FIG. 4 shows an example of a random access scheme 400 that supports narrow beam broadcast for random access in accordance with one or more examples as disclosed herein.

As described herein, in some examples, individual narrow beams 430 may be associated with a RACH occasion 420 and a preamble 425. In some examples, the quantity of preambles 425 r per SSB, represented by

$${M}_{r}^{SSB} ,$$

may be determined by

$${M}_{r}^{SSB} = \frac{1}{N} \cdot R ,$$

where N represents the quantity of SSBs associated with one RACH occasion 420 and R represents the quantity of preambles per SSB index, which may be configured by a parameter, such as ssb-perRACH-OccasionAndCB-PreamblesPerSSB.

In some examples, such as the example shown here, RACH occasions 420 and preambles 425 per SSB

$${M}_{r}^{SSB}$$

may be subdivided for the purpose of association with narrow beams. For example, the quantity of broadcasted narrow beams NB per SSB may be represented as

$${M}_{NB}^{SSB}$$

and the quantity of preambles per narrow beam may be represented as

$${M}_{r}^{NB} ,$$

where

$${M}_{r}^{NB} = \frac{1}{N} \cdot R \cdot \frac{1}{{M}_{NB}^{SSB}} = \frac{{M}_{r}^{SSB}}{{M}_{NB}^{SSB}} .$$

For example, given that a quantity of narrow beams per SSB as

$${M}_{NB}^{SSB} = 8$$

and that a parameter (e.g., ssb-perRACH-OccasionAndCB-PreamblesPerSSB) provides that N=oneHalf and R=32, then the quantity of preambles 425 per narrow beam 430 may be given by

$${M}_{r}^{NB} = \frac{1}{\frac{1}{2}} \cdot 32 \cdot \frac{1}{8} = 8$$

preambles. Such an arrangement is demonstrated in FIG. 4.

For example, as described herein, a UE may perform a cell search procedure (e.g., the cell search 320) to identify a wide beam (e.g., the wide beam 355) and a narrow beam (e.g., the narrow beam 360-c) that are to be used for communication. The UE may select the wide beam and the narrow beam based on characteristics of the wide beam and the narrow beam or communications associated therewith that are determined to be favorable to communications (e.g., that satisfy one or more associated thresholds). Having selected or identified the wide beam and the narrow beam the UE may then employ the mapping shown in the random access scheme 400 to determine a RACH occasion 420, a preamble 425, or both, and transmit a first random access message accordingly. For example, if the UE selects NB3 as the narrow beam, the UE may then determine that it is to use one or more of the preambles 425 included in the set of 24-31 (e.g., which corresponds to NB3), the RACH occasion N (e.g., which also corresponds to NB3), or both, for communication of a random access message (e.g., a RACH message, such as msg1).

In some examples, the broadcasted narrow beams 430 may also be employed for connected mode beam management. For example, in the presence of SSB FDM-ed associated narrow beams, beam management may at least partially, if not fully, use the broadcasted narrow beams. This is in contrast to some other approaches, in which narrow beam measurement (e.g., cri-L1-RSRP or SINR) involves dedicated resource usage. By employing techniques for performing beam management as described herein, the dedicated beam resource overhead may be reduced, as a network entity may not allocate resources for narrow beam management beyond those are not already published in the SSB FDM-ed narrow beams. Further, the use of periodic resources enables more accurate results for beam management, improving communications quality, availability, throughput, latency, overhead, and performance.

In some examples, information associated with the narrow beams (e.g., a configuration of the wide beams and the narrow beams, including which beams are FDM-ed and QCL-ed together) may be transmitted or output via control signaling to the UE (e.g., via MIB or SIB1). In some examples, the narrow beams may be associated with a RACH occasion and a preamble or preamble group. In some examples, beam management reports that indicate measurements or characteristics of the narrow beams (e.g., a reference signal receive or obtained power (RSRP) or a signal to interference and noise ratio (SINR), such as L1-RSRP or L1-SINR) may be employed.

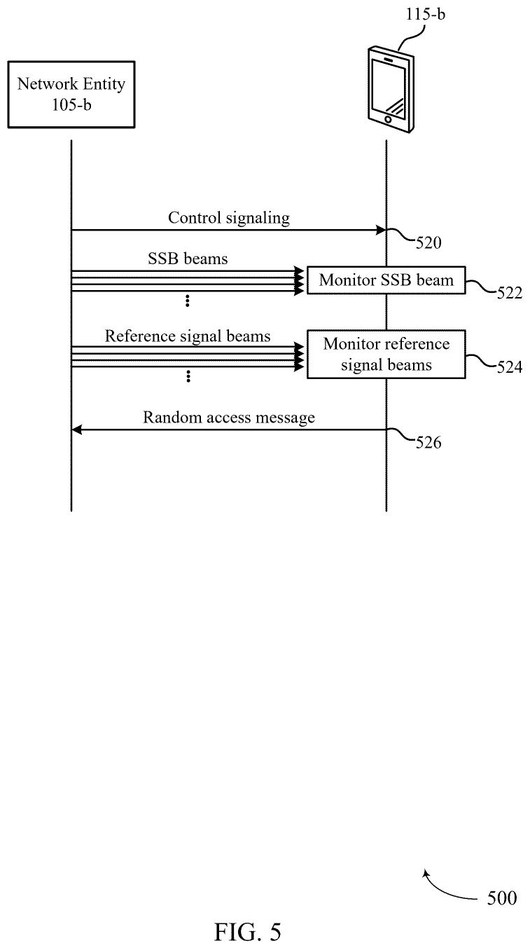

FIG. 5 shows an example of a process flow 500 that supports narrow beam broadcast for random access in accordance with one or more examples as disclosed herein.

The process flow 500 may implement various aspects of the present disclosure described herein. The elements described in the process flow 500 (e.g., UE 115-b and network entity 105-b) may be examples of similarly named elements described herein.

In the following description of the process flow 500, the operations between the various entities or elements may be performed in different orders or at different times. Some operations may also be left out of the process flow 500, or other operations may be added. Although the various entities or elements are shown performing the operations of the process flow 500, some aspects of some operations may also be performed by other entities or elements of the process flow 500 or by entities or elements that are not depicted in the process flow, or any combination thereof.

At 520, the UE 115-b may receive or obtain control signaling indicating a plurality of synchronization signal block (SSB) occasions for a plurality of SSB beams and indicating a plurality of random access occasions. In some examples, to receive or obtain the control signaling, the UE 115-b may receive or obtain the control signaling that indicates a quantity of reference signal beams per SSB occasion. In some examples, to receive or obtain the control signaling, the UE 115-b may receive or obtain the control signaling that indicates a quantity of random access preambles per reference signal beam.

At 522, the UE 115-b may monitor, in accordance with the control signaling, a first SSB beam of the plurality of SSB beams during a first SSB occasion of the plurality of SSB occasions.

At 524, the UE 115-b may monitor, during the first SSB occasion, a plurality of reference signal beams associated with the first SSB beam and each beam of the plurality of reference signal beams has a narrower beamwidth than the first SSB beam, and wherein each beam of the plurality of reference signal beams is quasi co-located and frequency domain multiplexed with the first SSB beam. In some examples, to monitor the plurality of reference signal beams, the UE 115-b may monitor for a respective reference signal beam of the plurality of reference signal beams in a respective symbol period of a plurality of symbol periods of the first SSB occasion. In some examples, to monitor the plurality of reference signal beams, the UE 115-b may monitor for the plurality of reference signal beams in a first frequency resource that is frequency domain multiplexed with a second frequency resource of the first SSB beam. In some examples, to monitor the plurality of reference signal beams, the UE 115-b may monitor for the plurality of reference signal beams in a first plurality of frequency resources and each frequency resource of the first plurality of frequency resources is frequency domain multiplexed with a second frequency resource of the first SSB beam.

In some examples, each reference signal beam of the plurality of reference signal beams is associated with a different random access occasion of the plurality of random access occasions. In some examples, each reference signal beam of the plurality of reference signal beams is associated with a different random access preamble of a plurality of random access preambles. In some examples, one or more resources associated with one or more of the plurality of reference signal beams are misaligned with a global synchronization channel number grid. In some examples, the plurality of reference signal beams may include a plurality of channel state information reference signal (CSI-RS) beams, a plurality of primary synchronization signal (PSS) beams, a plurality of secondary synchronization signal (SSS) beams, or any combination thereof.

At 526, the UE 115-b may transmit a random access message during a first random access occasion of the plurality of random access occasions, the first random access occasion indicating a first reference signal beam selected from the plurality of reference signal beams. In some examples, the random access message may include a first random access preamble of the plurality of random access preambles, the first random access preamble corresponding to the first reference signal beam and the first random access occasion.

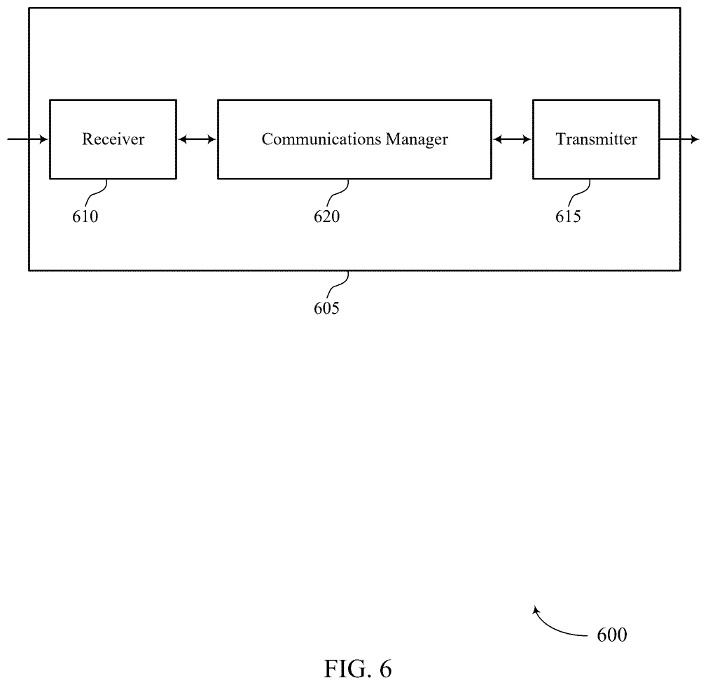

FIG. 6 shows a block diagram 600 of a device 605 that supports narrow beam broadcast for random access in accordance with one or more examples as disclosed herein. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to narrow beam broadcast for random access). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to narrow beam broadcast for random access). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of narrow beam broadcast for random access as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

Additionally, or alternatively, the communications manager 620 may support wireless communications in accordance with examples as disclosed herein. For example, the communications manager 620 is capable of, configured to, or operable to support a means for receiving control signaling indicating a set of multiple synchronization signal block (SSB) occasions for a set of multiple SSB beams and indicating a set of multiple random access occasions. The communications manager 620 is capable of, configured to, or operable to support a means for monitoring, in accordance with the control signaling, a first SSB beam of the set of multiple SSB beams during a first SSB occasion of the set of multiple SSB occasions. The communications manager 620 is capable of, configured to, or operable to support a means for monitoring, during the first SSB occasion, a set of multiple reference signal beams associated with the first SSB beam, where each beam of the set of multiple reference signal beams has a narrower beamwidth than the first SSB beam, and where each beam of the set of multiple reference signal beams is quasi co-located and frequency domain multiplexed with the first SSB beam. The communications manager 620 is capable of, configured to, or operable to support a means for transmitting a random access message during a first random access occasion of the set of multiple random access occasions, the first random access occasion indicating a first reference signal beam selected from the set of multiple reference signal beams.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing, reduced power consumption, more efficient utilization of communication resources, or any combination thereof.

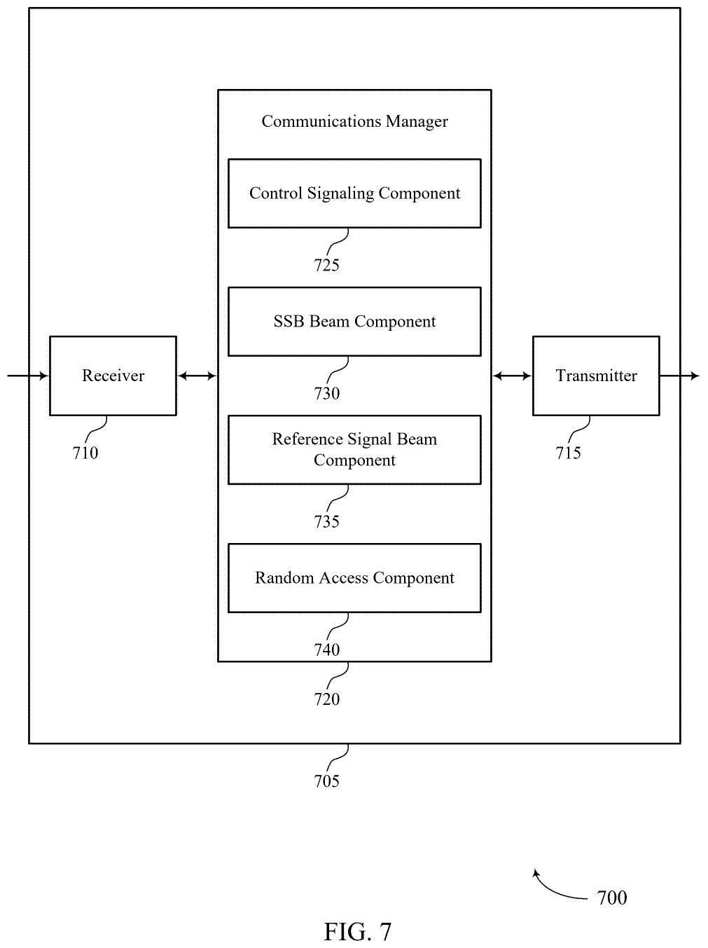

FIG. 7 shows a block diagram 700 of a device 705 that supports narrow beam broadcast for random access in accordance with one or more examples as disclosed herein. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to narrow beam broadcast for random access). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to narrow beam broadcast for random access). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of narrow beam broadcast for random access as described herein. For example, the communications manager 720 may include a control signaling component 725, an SSB beam component 730, a reference signal beam component 735, a random access component 740, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The control signaling component 725 is capable of, configured to, or operable to support a means for receiving control signaling indicating a set of multiple synchronization signal block (SSB) occasions for a set of multiple SSB beams and indicating a set of multiple random access occasions. The SSB beam component 730 is capable of, configured to, or operable to support a means for monitoring, in accordance with the control signaling, a first SSB beam of the set of multiple SSB beams during a first SSB occasion of the set of multiple SSB occasions. The reference signal beam component 735 is capable of, configured to, or operable to support a means for monitoring, during the first SSB occasion, a set of multiple reference signal beams associated with the first SSB beam, where each beam of the set of multiple reference signal beams has a narrower beamwidth than the first SSB beam, and where each beam of the set of multiple reference signal beams is quasi co-located and frequency domain multiplexed with the first SSB beam. The random access component 740 is capable of, configured to, or operable to support a means for transmitting a random access message during a first random access occasion of the set of multiple random access occasions, the first random access occasion indicating a first reference signal beam selected from the set of multiple reference signal beams.

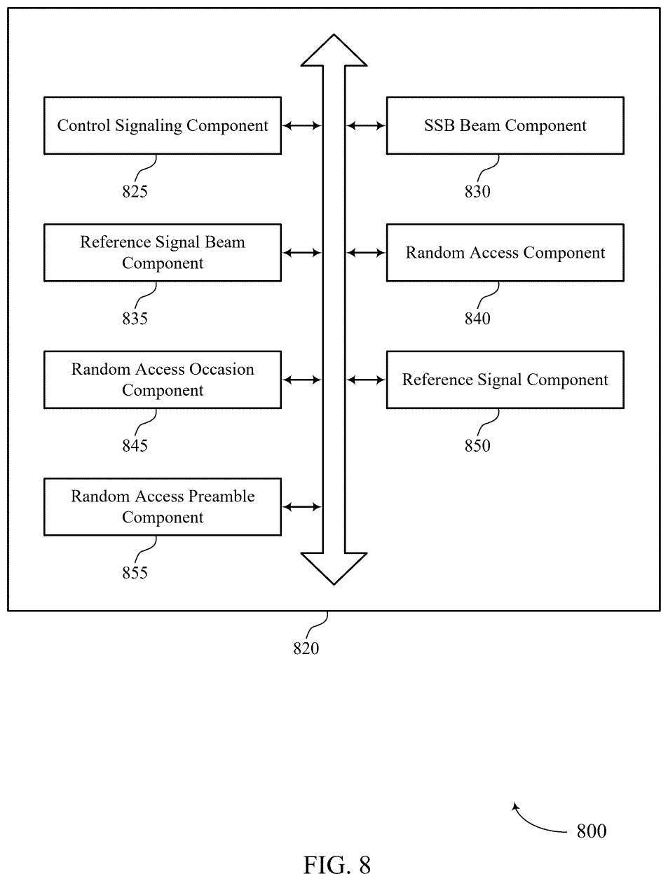

FIG. 8 shows a block diagram 800 of a communications manager 820 that supports narrow beam broadcast for random access in accordance with one or more examples as disclosed herein. The communications manager 820 may be an example of aspects of a communications manager 620, a communications manager 720, or both, as described herein. The communications manager 820, or various components thereof, may be an example of means for performing various aspects of narrow beam broadcast for random access as described herein. For example, the communications manager 820 may include a control signaling component 825, an SSB beam component 830, a reference signal beam component 835, a random access component 840, a random access occasion component 845, a reference signal component 850, a random access preamble component 855, or any combination thereof. Each of these components, or components or subcomponents thereof (e.g., one or more processors, one or more memories), may communicate, directly or indirectly, with one another (e.g., via one or more buses).

Additionally, or alternatively, the communications manager 820 may support wireless communications in accordance with examples as disclosed herein. The control signaling component 825 is capable of, configured to, or operable to support a means for receiving control signaling indicating a set of multiple synchronization signal block (SSB) occasions for a set of multiple SSB beams and indicating a set of multiple random access occasions. The SSB beam component 830 is capable of, configured to, or operable to support a means for monitoring, in accordance with the control signaling, a first SSB beam of the set of multiple SSB beams during a first SSB occasion of the set of multiple SSB occasions. The reference signal beam component 835 is capable of, configured to, or operable to support a means for monitoring, during the first SSB occasion, a set of multiple reference signal beams associated with the first SSB beam, where each beam of the set of multiple reference signal beams has a narrower beamwidth than the first SSB beam, and where each beam of the set of multiple reference signal beams is quasi co-located and frequency domain multiplexed with the first SSB beam. The random access component 840 is capable of, configured to, or operable to support a means for transmitting a random access message during a first random access occasion of the set of multiple random access occasions, the first random access occasion indicating a first reference signal beam selected from the set of multiple reference signal beams.

In some examples, to support monitoring the set of multiple reference signal beams, the reference signal beam component 835 is capable of, configured to, or operable to support a means for monitoring for a respective reference signal beam of the set of multiple reference signal beams in a respective symbol period of a set of multiple symbol periods of the first SSB occasion.

In some examples, to support monitoring the set of multiple reference signal beams, the reference signal beam component 835 is capable of, configured to, or operable to support a means for monitoring for the set of multiple reference signal beams in a first frequency resource that is frequency domain multiplexed with a second frequency resource of the first SSB beam.

In some examples, to support monitoring the set of multiple reference signal beams, the reference signal beam component 835 is capable of, configured to, or operable to support a means for monitoring for the set of multiple reference signal beams in a first set of multiple frequency resources, where each frequency resource of the first set of multiple frequency resources is frequency domain multiplexed with a second frequency resource of the first SSB beam.

In some examples, each reference signal beam of the set of multiple reference signal beams is associated with a different random access occasion of the set of multiple random access occasions.

In some examples, each reference signal beam of the set of multiple reference signal beams is associated with a different random access preamble of a set of multiple random access preambles. In some examples, the random access message includes a first random access preamble of the set of multiple random access preambles, the first random access preamble corresponding to the first reference signal beam and the first random access occasion.

In some examples, one or more resources associated with one or more of the set of multiple reference signal beams are misaligned with a global synchronization channel number grid.

In some examples, the set of multiple reference signal beams includes a set of multiple channel state information reference signal (CSI-RS) beams, a set of multiple PSS beams, a set of multiple SSS beams, or any combination thereof.

In some examples, to support receiving the control signaling, the control signaling component 825 is capable of, configured to, or operable to support a means for receiving the control signaling that indicates a quantity of reference signal beams per SSB occasion.

In some examples, to support receiving the control signaling, the control signaling component 825 is capable of, configured to, or operable to support a means for receiving the control signaling that indicates a quantity of random access preambles per reference signal beam.

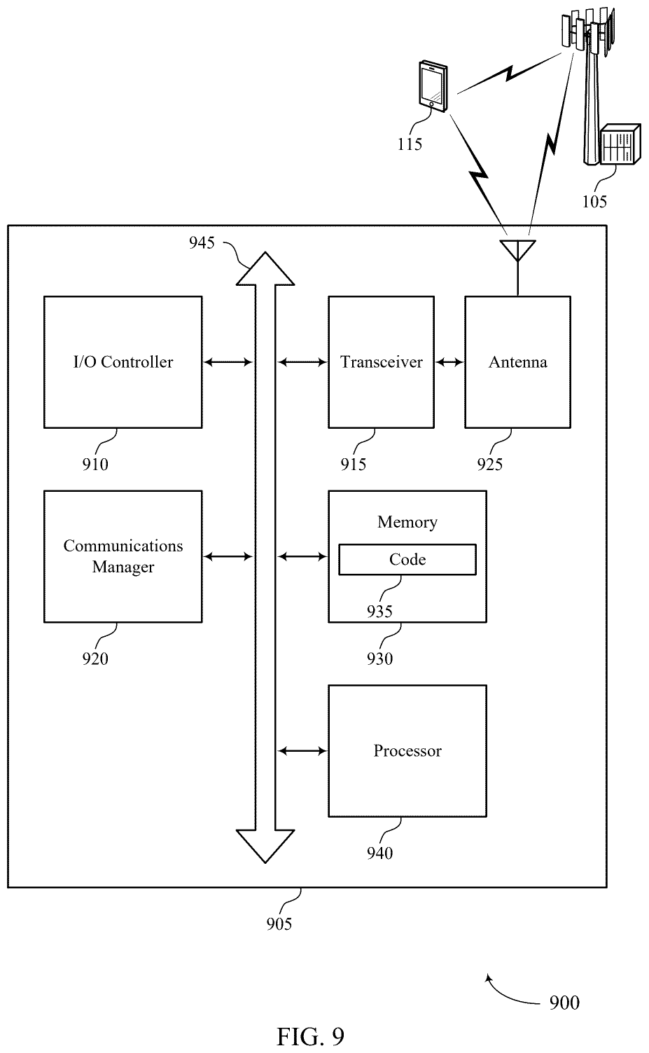

FIG. 9 shows a diagram of a system 900 including a device 905 that supports narrow beam broadcast for random access in accordance with one or more examples as disclosed herein. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting narrow beam broadcast for random access). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

Additionally, or alternatively, the communications manager 920 may support wireless communications in accordance with examples as disclosed herein. For example, the communications manager 920 is capable of, configured to, or operable to support a means for receiving control signaling indicating a set of multiple synchronization signal block (SSB) occasions for a set of multiple SSB beams and indicating a set of multiple random access occasions. The communications manager 920 is capable of, configured to, or operable to support a means for monitoring, in accordance with the control signaling, a first SSB beam of the set of multiple SSB beams during a first SSB occasion of the set of multiple SSB occasions. The communications manager 920 is capable of, configured to, or operable to support a means for monitoring, during the first SSB occasion, a set of multiple reference signal beams associated with the first SSB beam, where each beam of the set of multiple reference signal beams has a narrower beamwidth than the first SSB beam, and where each beam of the set of multiple reference signal beams is quasi co-located and frequency domain multiplexed with the first SSB beam. The communications manager 920 is capable of, configured to, or operable to support a means for transmitting a random access message during a first random access occasion of the set of multiple random access occasions, the first random access occasion indicating a first reference signal beam selected from the set of multiple reference signal beams.

By including or configuring the communications manager 920 in accordance with examples as described herein, the device 905 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of narrow beam broadcast for random access as described herein, or the at least one processor 940 and the at least one memory 930 may be otherwise configured to, individually or collectively, perform or support such operations.

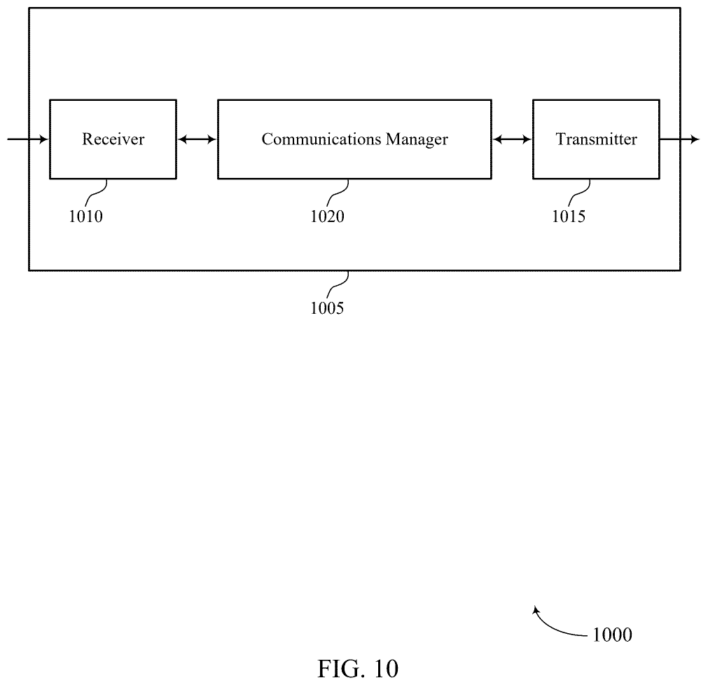

FIG. 10 shows a block diagram 1000 of a device 1005 that supports narrow beam broadcast for random access in accordance with one or more examples as disclosed herein. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of narrow beam broadcast for random access as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

Additionally, or alternatively, the communications manager 1020 may support wireless communications in accordance with examples as disclosed herein. For example, the communications manager 1020 is capable of, configured to, or operable to support a means for transmitting control signaling indicating a set of multiple synchronization signal block (SSB) occasions for a set of multiple SSB beams and indicating a set of multiple random access occasions. The communications manager 1020 is capable of, configured to, or operable to support a means for transmitting, in accordance with the control signaling, a first SSB beam of the set of multiple SSB beams during a first SSB occasion of the set of multiple SSB occasions. The communications manager 1020 is capable of, configured to, or operable to support a means for transmitting, during the first SSB occasion, a set of multiple reference signal beams associated with the first SSB beam, where each beam of the set of multiple reference signal beams has a narrower beamwidth than the first SSB beam, and where each beam of the set of multiple reference signal beams is quasi co-located and frequency domain multiplexed with the first SSB beam. The communications manager 1020 is capable of, configured to, or operable to support a means for receiving a random access message during a first random access occasion of the set of multiple random access occasions, the first random access occasion indicating a first reference signal beam selected from the set of multiple reference signal beams.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for reduced processing, reduced power consumption, more efficient utilization of communication resources, or any combination thereof.

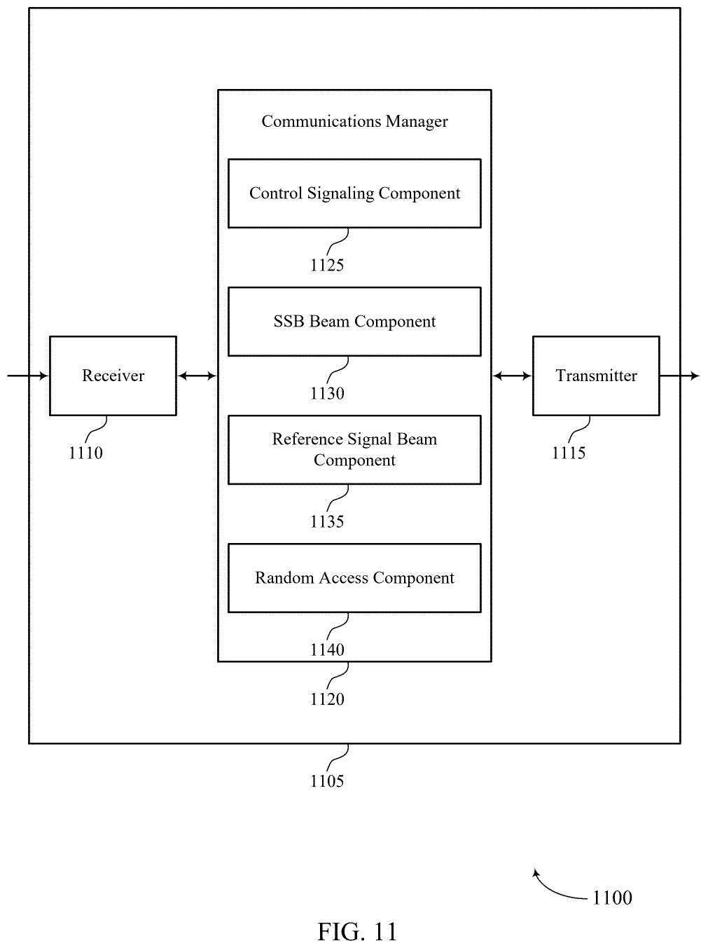

FIG. 11 shows a block diagram 1100 of a device 1105 that supports narrow beam broadcast for random access in accordance with one or more examples as disclosed herein. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of narrow beam broadcast for random access as described herein. For example, the communications manager 1120 may include a control signaling component 1125, an SSB beam component 1130, a reference signal beam component 1135, a random access component 1140, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The control signaling component 1125 is capable of, configured to, or operable to support a means for transmitting control signaling indicating a set of multiple synchronization signal block (SSB) occasions for a set of multiple SSB beams and indicating a set of multiple random access occasions. The SSB beam component 1130 is capable of, configured to, or operable to support a means for transmitting, in accordance with the control signaling, a first SSB beam of the set of multiple SSB beams during a first SSB occasion of the set of multiple SSB occasions. The reference signal beam component 1135 is capable of, configured to, or operable to support a means for transmitting, during the first SSB occasion, a set of multiple reference signal beams associated with the first SSB beam, where each beam of the set of multiple reference signal beams has a narrower beamwidth than the first SSB beam, and where each beam of the set of multiple reference signal beams is quasi co-located and frequency domain multiplexed with the first SSB beam. The random access component 1140 is capable of, configured to, or operable to support a means for receiving a random access message during a first random access occasion of the set of multiple random access occasions, the first random access occasion indicating a first reference signal beam selected from the set of multiple reference signal beams.

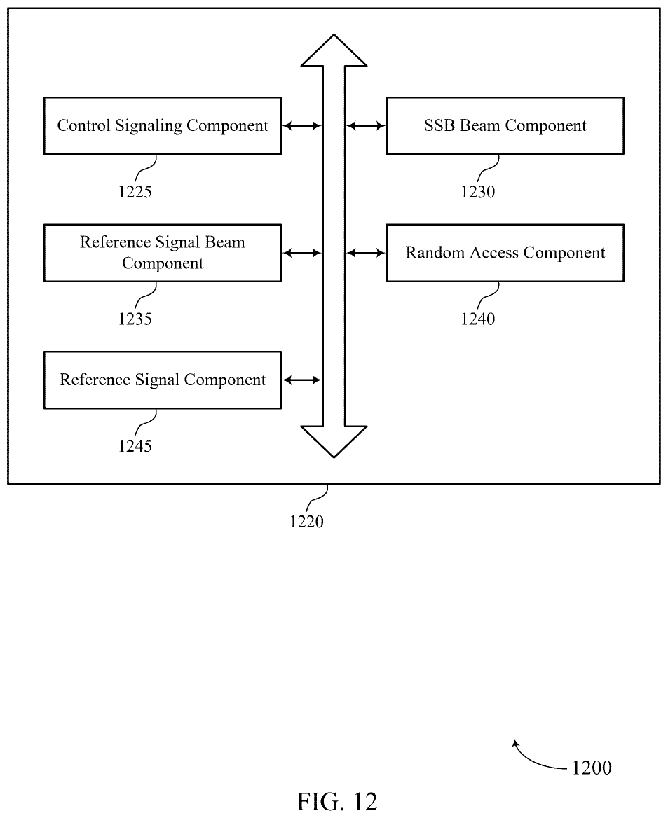

FIG. 12 shows a block diagram 1200 of a communications manager 1220 that supports narrow beam broadcast for random access in accordance with one or more examples as disclosed herein. The communications manager 1220 may be an example of aspects of a communications manager 1020, a communications manager 1120, or both, as described herein. The communications manager 1220, or various components thereof, may be an example of means for performing various aspects of narrow beam broadcast for random access as described herein. For example, the communications manager 1220 may include a control signaling component 1225, an SSB beam component 1230, a reference signal beam component 1235, a random access component 1240, a reference signal component 1245, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

Additionally, or alternatively, the communications manager 1220 may support wireless communications in accordance with examples as disclosed herein. The control signaling component 1225 is capable of, configured to, or operable to support a means for transmitting control signaling indicating a set of multiple synchronization signal block (SSB) occasions for a set of multiple SSB beams and indicating a set of multiple random access occasions. The SSB beam component 1230 is capable of, configured to, or operable to support a means for transmitting, in accordance with the control signaling, a first SSB beam of the set of multiple SSB beams during a first SSB occasion of the set of multiple SSB occasions. The reference signal beam component 1235 is capable of, configured to, or operable to support a means for transmitting, during the first SSB occasion, a set of multiple reference signal beams associated with the first SSB beam, where each beam of the set of multiple reference signal beams has a narrower beamwidth than the first SSB beam, and where each beam of the set of multiple reference signal beams is quasi co-located and frequency domain multiplexed with the first SSB beam. The random access component 1240 is capable of, configured to, or operable to support a means for receiving a random access message during a first random access occasion of the set of multiple random access occasions, the first random access occasion indicating a first reference signal beam selected from the set of multiple reference signal beams.

In some examples, to support transmitting the set of multiple reference signal beams, the reference signal beam component 1235 is capable of, configured to, or operable to support a means for transmitting a respective reference signal beam of the set of multiple reference signal beams in a respective symbol period of a set of multiple symbol periods of the first SSB occasion.

In some examples, to support transmitting the set of multiple reference signal beams, the reference signal beam component 1235 is capable of, configured to, or operable to support a means for transmitting the set of multiple reference signal beams in a first frequency resource that is frequency domain multiplexed with a second frequency resource of the first SSB beam.

In some examples, to support transmitting the set of multiple reference signal beams, the reference signal beam component 1235 is capable of, configured to, or operable to support a means for transmitting the set of multiple reference signal beams in a first set of multiple frequency resources, where each frequency resource of the first set of multiple frequency resources is frequency domain multiplexed with a second frequency resource of the first SSB beam.

In some examples, each reference signal beam of the set of multiple reference signal beams is associated with a different random access occasion of the set of multiple random access occasions.

In some examples, each reference signal beam of the set of multiple reference signal beams is associated with a different random access preamble of a set of multiple random access preambles. In some examples, the random access message includes a first random access preamble of the set of multiple random access preambles, the first random access preamble corresponding to the first reference signal beam and the first random access occasion.

In some examples, one or more resources associated with one or more of the set of multiple reference signal beams are misaligned with a global synchronization channel number grid.

In some examples, the set of multiple reference signal beams includes a set of multiple channel state information reference signal (CSI-RS) beams, a set of multiple PSS beams, a set of multiple SSS beams, or any combination thereof.

In some examples, to support transmitting the control signaling, the control signaling component 1225 is capable of, configured to, or operable to support a means for transmitting the control signaling that indicates a quantity of reference signal beams per SSB occasion.

In some examples, to support transmitting the control signaling, the control signaling component 1225 is capable of, configured to, or operable to support a means for transmitting the control signaling that indicates a quantity of random access preambles per reference signal beam.

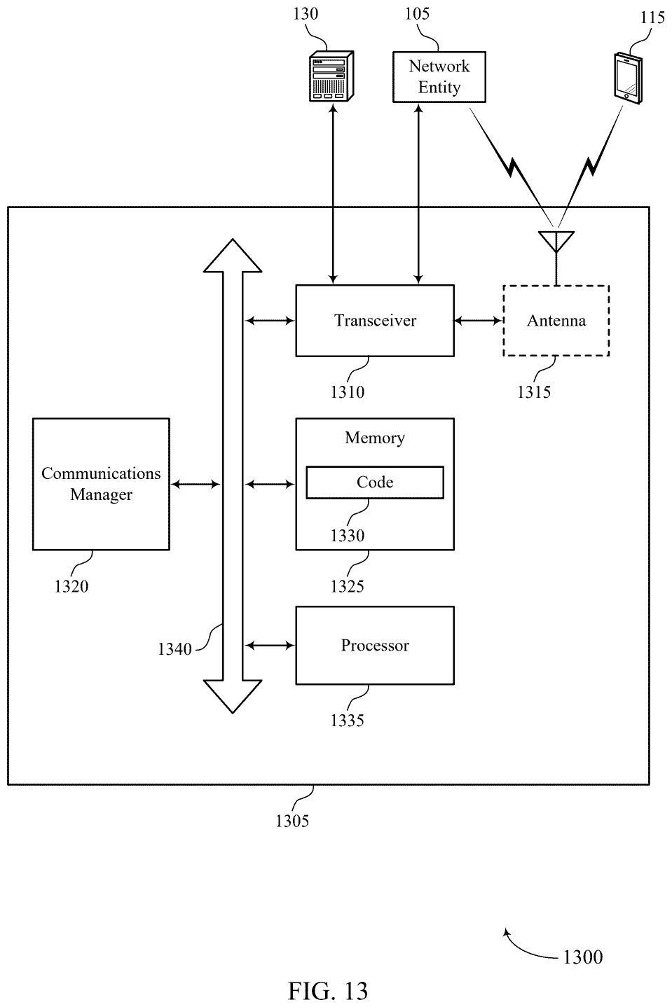

FIG. 13 shows a diagram of a system 1300 including a device 1305 that supports narrow beam broadcast for random access in accordance with one or more examples as disclosed herein. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting narrow beam broadcast for random access). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

Additionally, or alternatively, the communications manager 1320 may support wireless communications in accordance with examples as disclosed herein. For example, the communications manager 1320 is capable of, configured to, or operable to support a means for transmitting control signaling indicating a set of multiple synchronization signal block (SSB) occasions for a set of multiple SSB beams and indicating a set of multiple random access occasions. The communications manager 1320 is capable of, configured to, or operable to support a means for transmitting, in accordance with the control signaling, a first SSB beam of the set of multiple SSB beams during a first SSB occasion of the set of multiple SSB occasions. The communications manager 1320 is capable of, configured to, or operable to support a means for transmitting, during the first SSB occasion, a set of multiple reference signal beams associated with the first SSB beam, where each beam of the set of multiple reference signal beams has a narrower beamwidth than the first SSB beam, and where each beam of the set of multiple reference signal beams is quasi co-located and frequency domain multiplexed with the first SSB beam. The communications manager 1320 is capable of, configured to, or operable to support a means for receiving a random access message during a first random access occasion of the set of multiple random access occasions, the first random access occasion indicating a first reference signal beam selected from the set of multiple reference signal beams.

By including or configuring the communications manager 1320 in accordance with examples as described herein, the device 1305 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of narrow beam broadcast for random access as described herein, or the at least one processor 1335 and the at least one memory 1325 may be otherwise configured to, individually or collectively, perform or support such operations.

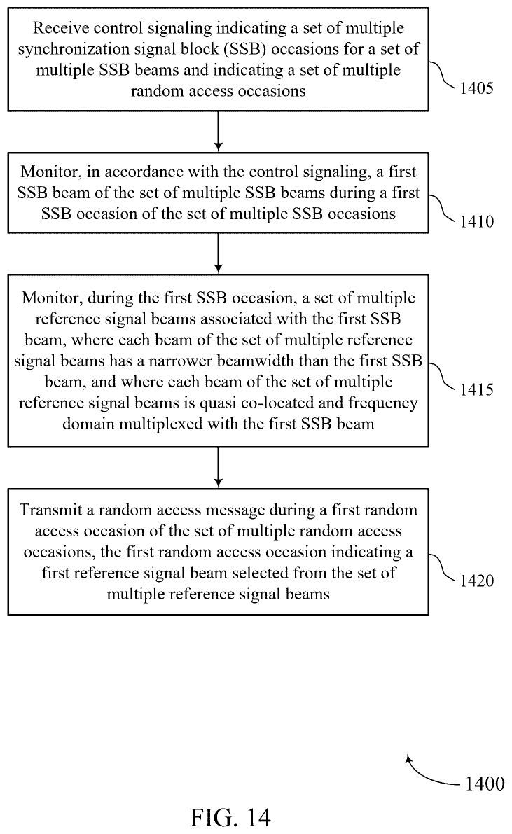

FIG. 14 shows a flowchart illustrating a method 1400 that supports narrow beam broadcast for random access in accordance with one or more examples as disclosed herein. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving control signaling indicating a set of multiple synchronization signal block (SSB) occasions for a set of multiple SSB beams and indicating a set of multiple random access occasions. The operations of 1405 may be performed in accordance with examples as disclosed herein. In some examples, aspects of the operations of 1405 may be performed by a control signaling component 825 as described with reference to FIG. 8.

At 1410, the method may include monitoring, in accordance with the control signaling, a first SSB beam of the set of multiple SSB beams during a first SSB occasion of the set of multiple SSB occasions. The operations of 1410 may be performed in accordance with examples as disclosed herein. In some examples, aspects of the operations of 1410 may be performed by an SSB beam component 830 as described with reference to FIG. 8.

At 1415, the method may include monitoring, during the first SSB occasion, a set of multiple reference signal beams associated with the first SSB beam, where each beam of the set of multiple reference signal beams has a narrower beamwidth than the first SSB beam, and where each beam of the set of multiple reference signal beams is quasi co-located and frequency domain multiplexed with the first SSB beam. The operations of 1415 may be performed in accordance with examples as disclosed herein. In some examples, aspects of the operations of 1415 may be performed by a reference signal beam component 835 as described with reference to FIG. 8.

At 1420, the method may include transmitting a random access message during a first random access occasion of the set of multiple random access occasions, the first random access occasion indicating a first reference signal beam selected from the set of multiple reference signal beams. The operations of 1420 may be performed in accordance with examples as disclosed herein. In some examples, aspects of the operations of 1420 may be performed by a random access component 840 as described with reference to FIG. 8.

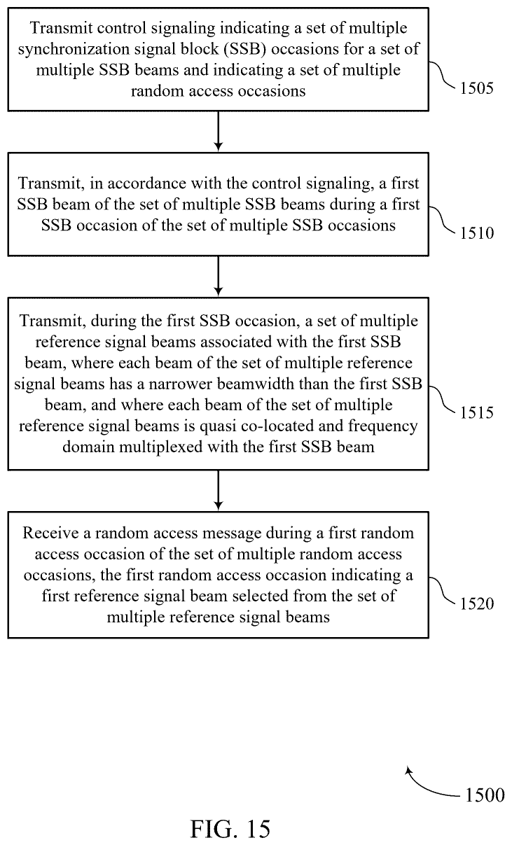

FIG. 15 shows a flowchart illustrating a method 1500 that supports narrow beam broadcast for random access in accordance with one or more examples as disclosed herein. The operations of the method 1500 may be implemented by a network entity or its components as described herein. For example, the operations of the method 1500 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1505, the method may include transmitting control signaling indicating a set of multiple synchronization signal block (SSB) occasions for a set of multiple SSB beams and indicating a set of multiple random access occasions. The operations of 1505 may be performed in accordance with examples as disclosed herein. In some examples, aspects of the operations of 1505 may be performed by a control signaling component 1225 as described with reference to FIG. 12.

At 1510, the method may include transmitting, in accordance with the control signaling, a first SSB beam of the set of multiple SSB beams during a first SSB occasion of the set of multiple SSB occasions. The operations of 1510 may be performed in accordance with examples as disclosed herein. In some examples, aspects of the operations of 1510 may be performed by an SSB beam component 1230 as described with reference to FIG. 12.

At 1515, the method may include transmitting, during the first SSB occasion, a set of multiple reference signal beams associated with the first SSB beam, where each beam of the set of multiple reference signal beams has a narrower beamwidth than the first SSB beam, and where each beam of the set of multiple reference signal beams is quasi co-located and frequency domain multiplexed with the first SSB beam. The operations of 1515 may be performed in accordance with examples as disclosed herein. In some examples, aspects of the operations of 1515 may be performed by a reference signal beam component 1235 as described with reference to FIG. 12.

At 1520, the method may include receiving a random access message during a first random access occasion of the set of multiple random access occasions, the first random access occasion indicating a first reference signal beam selected from the set of multiple reference signal beams. The operations of 1520 may be performed in accordance with examples as disclosed herein. In some examples, aspects of the operations of 1520 may be performed by a random access component 1240 as described with reference to FIG. 12.

The following provides an overview of aspects of the present disclosure:

Aspect 1: A method for wireless communications at a UE, comprising: receiving control signaling indicating a plurality of synchronization signal block (SSB) occasions for a plurality of SSB beams and indicating a plurality of random access occasions; monitoring, in accordance with the control signaling, a first SSB beam of the plurality of SSB beams during a first SSB occasion of the plurality of SSB occasions; monitoring, during the first SSB occasion, a plurality of reference signal beams associated with the first SSB beam, wherein each beam of the plurality of reference signal beams has a narrower beamwidth than the first SSB beam, and wherein each beam of the plurality of reference signal beams is quasi co-located and frequency domain multiplexed with the first SSB beam; and transmitting a random access message during a first random access occasion of the plurality of random access occasions, the first random access occasion indicating a first reference signal beam selected from the plurality of reference signal beams.

Aspect 2: The method of aspect 1, wherein monitoring the plurality of reference signal beams further comprises: monitoring for a respective reference signal beam of the plurality of reference signal beams in a respective symbol period of a plurality of symbol periods of the first SSB occasion.

Aspect 3: The method of any of aspects 1 through 2, wherein monitoring the plurality of reference signal beams further comprises: monitoring for the plurality of reference signal beams in a first frequency resource that is frequency domain multiplexed with a second frequency resource of the first SSB beam.

Aspect 4: The method of any of aspects 1 through 3, wherein monitoring the plurality of reference signal beams further comprises: monitoring for the plurality of reference signal beams in a first plurality of frequency resources, wherein each frequency resource of the first plurality of frequency resources is frequency domain multiplexed with a second frequency resource of the first SSB beam.

Aspect 5: The method of any of aspects 1 through 4, wherein each reference signal beam of the plurality of reference signal beams is associated with a different random access occasion of the plurality of random access occasions.

Aspect 6: The method of aspect 5, wherein each reference signal beam of the plurality of reference signal beams is associated with a different random access preamble of a plurality of random access preambles; and the random access message comprises a first random access preamble of the plurality of random access preambles, the first random access preamble corresponding to the first reference signal beam and the first random access occasion.

Aspect 7: The method of any of aspects 1 through 6, wherein one or more resources associated with one or more of the plurality of reference signal beams are misaligned with a global synchronization channel number grid.

Aspect 8: The method of any of aspects 1 through 7, wherein the plurality of reference signal beams comprises a plurality of channel state information reference signal (CSI-RS) beams, a plurality of PSS beams, a plurality of SSS beams, or any combination thereof.

Aspect 9: The method of any of aspects 1 through 8, wherein receiving the control signaling further comprises: receiving the control signaling that indicates a quantity of reference signal beams per SSB occasion.

Aspect 10: The method of any of aspects 1 through 9, wherein receiving the control signaling further comprises: receiving the control signaling that indicates a quantity of random access preambles per reference signal beam.

Aspect 11: A method for wireless communications at a network entity, comprising: transmitting control signaling indicating a plurality of synchronization signal block (SSB) occasions for a plurality of SSB beams and indicating a plurality of random access occasions; transmitting, in accordance with the control signaling, a first SSB beam of the plurality of SSB beams during a first SSB occasion of the plurality of SSB occasions; transmitting, during the first SSB occasion, a plurality of reference signal beams associated with the first SSB beam, wherein each beam of the plurality of reference signal beams has a narrower beamwidth than the first SSB beam, and wherein each beam of the plurality of reference signal beams is quasi co-located and frequency domain multiplexed with the first SSB beam; and receiving a random access message during a first random access occasion of the plurality of random access occasions, the first random access occasion indicating a first reference signal beam selected from the plurality of reference signal beams.

Aspect 12: The method of aspect 11, wherein transmitting the plurality of reference signal beams further comprises: transmitting a respective reference signal beam of the plurality of reference signal beams in a respective symbol period of a plurality of symbol periods of the first SSB occasion.

Aspect 13: The method of any of aspects 11 through 12, wherein transmitting the plurality of reference signal beams further comprises: transmitting the plurality of reference signal beams in a first frequency resource that is frequency domain multiplexed with a second frequency resource of the first SSB beam.

Aspect 14: The method of any of aspects 11 through 13, wherein transmitting the plurality of reference signal beams further comprises: transmitting the plurality of reference signal beams in a first plurality of frequency resources, wherein each frequency resource of the first plurality of frequency resources is frequency domain multiplexed with a second frequency resource of the first SSB beam.

Aspect 15: The method of any of aspects 11 through 14, wherein each reference signal beam of the plurality of reference signal beams is associated with a different random access occasion of the plurality of random access occasions.

Aspect 16: The method of aspect 15, wherein each reference signal beam of the plurality of reference signal beams is associated with a different random access preamble of a plurality of random access preambles; and the random access message comprises a first random access preamble of the plurality of random access preambles, the first random access preamble corresponding to the first reference signal beam and the first random access occasion.

Aspect 17: The method of any of aspects 11 through 16, wherein one or more resources associated with one or more of the plurality of reference signal beams are misaligned with a global synchronization channel number grid.

Aspect 18: The method of any of aspects 11 through 17, wherein the plurality of reference signal beams comprises a plurality of channel state information reference signal (CSI-RS) beams, a plurality of PSS beams, a plurality of SSS beams, or any combination thereof.

Aspect 19: The method of any of aspects 11 through 18, wherein transmitting the control signaling further comprises: transmitting the control signaling that indicates a quantity of reference signal beams per SSB occasion.

Aspect 20: The method of any of aspects 11 through 19, wherein transmitting the control signaling further comprises: transmitting the control signaling that indicates a quantity of random access preambles per reference signal beam.

Aspect 21: A UE for wireless communications, comprising one or more memories storing processor-executable code, and one or more processors coupled with the one or more memories and individually or collectively operable to execute the code to cause the UE to perform a method of any of aspects 1 through 10.

Aspect 22: A UE for wireless communications, comprising at least one means for performing a method of any of aspects 1 through 10.

Aspect 23: A non-transitory computer-readable medium storing code for wireless communications, the code comprising instructions executable by one or more processors to perform a method of any of aspects 1 through 10.

Aspect 24: A network entity for wireless communications, comprising one or more memories storing processor-executable code, and one or more processors coupled with the one or more memories and individually or collectively operable to execute the code to cause the network entity to perform a method of any of aspects 11 through 20.

Aspect 25: A network entity for wireless communications, comprising at least one means for performing a method of any of aspects 11 through 20.

Aspect 26: A non-transitory computer-readable medium storing code for wireless communications, the code comprising instructions executable by one or more processors to perform a method of any of aspects 11 through 20.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control signaling indicating a plurality of synchronization signal block (SSB) occasions for a plurality of SSB beams and indicating a plurality of random access occasions;
monitor, in accordance with the control signaling, a first SSB beam of the plurality of SSB beams during a first SSB occasion of the plurality of SSB occasions;
monitor, during the first SSB occasion, a plurality of reference signal beams associated with the first SSB beam, wherein each beam of the plurality of reference signal beams has a narrower beamwidth than the first SSB beam, and wherein each beam of the plurality of reference signal beams is quasi co-located and frequency domain multiplexed with the first SSB beam; and
transmit a random access message during a first random access occasion of the plurality of random access occasions, the first random access occasion indicating a first reference signal beam selected from the plurality of reference signal beams.

2. The UE of claim 1, wherein, to monitor the plurality of reference signal beams, the one or more processors are individually or collectively further operable to execute the code to cause the UE to:
monitor for a respective reference signal beam of the plurality of reference signal beams in a respective symbol period of a plurality of symbol periods of the first SSB occasion.

3. The UE of claim 1, wherein, to monitor the plurality of reference signal beams, the one or more processors are individually or collectively further operable to execute the code to cause the UE to:
monitor for the plurality of reference signal beams in a first frequency resource that is frequency domain multiplexed with a second frequency resource of the first SSB beam.

4. The UE of claim 1, wherein, to monitor the plurality of reference signal beams, the one or more processors are individually or collectively further operable to execute the code to cause the UE to:
monitor for the plurality of reference signal beams in a first plurality of frequency resources, wherein each frequency resource of the first plurality of frequency resources is frequency domain multiplexed with a second frequency resource of the first SSB beam.

5. The UE of claim 1, wherein each reference signal beam of the plurality of reference signal beams is associated with a different random access occasion of the plurality of random access occasions.

6. The UE of claim 5, wherein:
each reference signal beam of the plurality of reference signal beams is associated with a different random access preamble of a plurality of random access preambles; and
the random access message comprises a first random access preamble of the plurality of random access preambles, the first random access preamble corresponding to the first reference signal beam and the first random access occasion.

7. The UE of claim 1, wherein one or more resources associated with one or more of the plurality of reference signal beams are misaligned with a global synchronization channel number grid.

8. The UE of claim 1, wherein the plurality of reference signal beams comprises a plurality of channel state information reference signal (CSI-RS) beams, a plurality of primary synchronization signal (PSS) beams, a plurality of secondary synchronization signal (SSS) beams, or any combination thereof.

9. The UE of claim 1, wherein, to receive the control signaling, the one or more processors are individually or collectively further operable to execute the code to cause the UE to:
receive the control signaling that indicates a quantity of reference signal beams per SSB occasion.

10. The UE of claim 1, wherein, to receive the control signaling, the one or more processors are individually or collectively further operable to execute the code to cause the UE to:
receive the control signaling that indicates a quantity of random access preambles per reference signal beam.

11. A network entity, comprising:
one or more memories storing processor-executable code; and
one or more processors coupled with the one or more memories and individually or collectively operable to execute the code to cause the network entity to:
transmit control signaling indicating a plurality of synchronization signal block (SSB) occasions for a plurality of SSB beams and indicating a plurality of random access occasions;
transmit, in accordance with the control signaling, a first SSB beam of the plurality of SSB beams during a first SSB occasion of the plurality of SSB occasions;
transmit, during the first SSB occasion, a plurality of reference signal beams associated with the first SSB beam, wherein each beam of the plurality of reference signal beams has a narrower beamwidth than the first SSB beam, and wherein each beam of the plurality of reference signal beams is quasi co-located and frequency domain multiplexed with the first SSB beam; and
receive a random access message during a first random access occasion of the plurality of random access occasions, the first random access occasion indicating a first reference signal beam selected from the plurality of reference signal beams.

12. The network entity of claim 11, wherein, to transmit the plurality of reference signal beams, the one or more processors are individually or collectively further operable to execute the code to cause the network entity to:
transmit a respective reference signal beam of the plurality of reference signal beams in a respective symbol period of a plurality of symbol periods of the first SSB occasion.

13. The network entity of claim 11, wherein, to transmit the plurality of reference signal beams, the one or more processors are individually or collectively further operable to execute the code to cause the network entity to:
transmit the plurality of reference signal beams in a first frequency resource that is frequency domain multiplexed with a second frequency resource of the first SSB beam.

14. The network entity of claim 11, wherein, to transmit the plurality of reference signal beams, the one or more processors are individually or collectively further operable to execute the code to cause the network entity to:
transmit the plurality of reference signal beams in a first plurality of frequency resources, wherein each frequency resource of the first plurality of frequency resources is frequency domain multiplexed with a second frequency resource of the first SSB beam.

15. The network entity of claim 11, wherein each reference signal beam of the plurality of reference signal beams is associated with a different random access occasion of the plurality of random access occasions.

16. The network entity of claim 15, wherein:
each reference signal beam of the plurality of reference signal beams is associated with a different random access preamble of a plurality of random access preambles; and
the random access message comprises a first random access preamble of the plurality of random access preambles, the first random access preamble corresponding to the first reference signal beam and the first random access occasion.

17. The network entity of claim 11, wherein one or more resources associated with one or more of the plurality of reference signal beams are misaligned with a global synchronization channel number grid.

18. The network entity of claim 11, wherein the plurality of reference signal beams comprises a plurality of channel state information reference signal (CSI-RS) beams, a plurality of primary synchronization signal (PSS) beams, a plurality of secondary synchronization signal (SSS) beams, or any combination thereof.

19. The network entity of claim 11, wherein, to transmit the control signaling, the one or more processors are individually or collectively further operable to execute the code to cause the network entity to:
transmit the control signaling that indicates a quantity of reference signal beams per SSB occasion.

20. The network entity of claim 11, wherein, to transmit the control signaling, the one or more processors are individually or collectively further operable to execute the code to cause the network entity to:
transmit the control signaling that indicates a quantity of random access preambles per reference signal beam.

21. A method for wireless communications at a user equipment (UE), comprising:
receiving control signaling indicating a plurality of synchronization signal block (SSB) occasions for a plurality of SSB beams and indicating a plurality of random access occasions;
monitoring, in accordance with the control signaling, a first SSB beam of the plurality of SSB beams during a first SSB occasion of the plurality of SSB occasions;
monitoring, during the first SSB occasion, a plurality of reference signal beams associated with the first SSB beam, wherein each beam of the plurality of reference signal beams has a narrower beamwidth than the first SSB beam, and wherein each beam of the plurality of reference signal beams is quasi co-located and frequency domain multiplexed with the first SSB beam; and
transmitting a random access message during a first random access occasion of the plurality of random access occasions, the first random access occasion indicating a first reference signal beam selected from the plurality of reference signal beams.

22. The method of claim 21, wherein monitoring the plurality of reference signal beams further comprises:
monitoring for a respective reference signal beam of the plurality of reference signal beams in a respective symbol period of a plurality of symbol periods of the first SSB occasion.

23. The method of claim 21, wherein monitoring the plurality of reference signal beams further comprises:
monitoring for the plurality of reference signal beams in a first frequency resource that is frequency domain multiplexed with a second frequency resource of the first SSB beam.

24. The method of claim 21, wherein monitoring the plurality of reference signal beams further comprises:
monitoring for the plurality of reference signal beams in a first plurality of frequency resources, wherein each frequency resource of the first plurality of frequency resources is frequency domain multiplexed with a second frequency resource of the first SSB beam.

25. The method of claim 21, wherein each reference signal beam of the plurality of reference signal beams is associated with a different random access occasion of the plurality of random access occasions.

26. A method for wireless communications at a network entity, comprising:
transmitting control signaling indicating a plurality of synchronization signal block (SSB) occasions for a plurality of SSB beams and indicating a plurality of random access occasions;
transmitting, in accordance with the control signaling, a first SSB beam of the plurality of SSB beams during a first SSB occasion of the plurality of SSB occasions;
transmitting, during the first SSB occasion, a plurality of reference signal beams associated with the first SSB beam, wherein each beam of the plurality of reference signal beams has a narrower beamwidth than the first SSB beam, and wherein each beam of the plurality of reference signal beams is quasi co-located and frequency domain multiplexed with the first SSB beam; and
receiving a random access message during a first random access occasion of the plurality of random access occasions, the first random access occasion indicating a first reference signal beam selected from the plurality of reference signal beams.

27. The method of claim 26, wherein transmitting the plurality of reference signal beams further comprises:
transmitting a respective reference signal beam of the plurality of reference signal beams in a respective symbol period of a plurality of symbol periods of the first SSB occasion.

28. The method of claim 26, wherein transmitting the plurality of reference signal beams further comprises:
transmitting the plurality of reference signal beams in a first frequency resource that is frequency domain multiplexed with a second frequency resource of the first SSB beam.

29. The method of claim 26, wherein transmitting the plurality of reference signal beams further comprises:
transmitting the plurality of reference signal beams in a first plurality of frequency resources, wherein each frequency resource of the first plurality of frequency resources is frequency domain multiplexed with a second frequency resource of the first SSB beam.

30. The method of claim 26, wherein each reference signal beam of the plurality of reference signal beams is associated with a different random access occasion of the plurality of random access occasions.
